(19) United States
(12) Patent Application Publication
(10) Pub. No.: US 2019/0026691 A1
(43) Pub. Date: Jan. 24, 2019

(54) METHOD, APPARATUS, AND SYSTEM FOR SCHEDULING LOGISTIC RESOURCES

(71) Applicant: CAINIAO SMART LOGISTICS HOLDING LIMITED, GRAND CAYMAN (KY)

(72) Inventors: YUEYANG CHEN, HANGZHOU (CN); JUNWEI KANG, HANGZHOU (CN)

(21) Appl. No.: 16/140,876

(22) Filed: Sep. 25, 2018

Related U.S. Application Data
(63) Continuation of application No. PCT/CN2017/078043, filed on Mar. 24, 2017.

(30) Foreign Application Priority Data
Mar. 31, 2016 (CN) 201610202195.7

(51) Int. Cl. G06Q 10/08

(52) U.S. Cl. CPC G06Q 10/087; G06Q 10/08355; G06Q 10/0838

(57) ABSTRACT

A method, an apparatus, and a system for scheduling logistic resources are provided. The method, to be implemented by a computing device, comprises: determining a warehouse resource from a warehouse resource providing terminal and a distribution resource from a distribution resource providing terminal; integrating the warehouse resource and the distribution resource according to a resource integration rule to obtain a logistic resource that satisfies a condition; and releasing the logistic resource, to enable a commodity object providing terminal requesting to use the logistic resource to schedule the logistic resource.

### CROSS-REFERENCE TO RELATED APPLICATIONS

This application is a continuation application of International Patent Application No. PCT/CN2017/078043, filed on Mar. 24, 2017, which claims priority to China Patent Application No. 201610202195.7, filed with the China Patent Office on Mar. 31, 2016 and entitled “METHOD, APPARATUS, AND SYSTEM FOR SCHEDULING LOGISTIC RESOURCES.” The above referenced applications are incorporated herein by reference in their entirety.

### TECHNICAL FIELD

The present application relates to the technical fields of Internet information processing and logistics and distribution, and in particular, to a method, an apparatus, and a system for scheduling logistic resources.

### BACKGROUND

With the development of Internet technology, various electronic commerce platforms have emerged from Internet platforms. These electronic commerce platforms may provide various different online services for users. These online services provide great convenience for the users.

For example, a user purchases daily necessities through an electronic commerce platform that mainly provides daily necessities and services. When receiving order information from the user (e.g., the order information may include daily necessities purchased by the user), the electronic commerce platform may distribute the needed daily necessities to the user according to location information included in the order information. In this way, the user enjoys an online service of purchasing daily necessities provided by the electronic commerce platform.

A plurality of different commodity object providing terminals may use one electronic commerce platform to provide online services for users. Online services provided by a commodity object providing terminal include, but are not limited to, providing commodity object information and delivering the purchased commodity object to a user that purchases the commodity object. Accordingly, one important indicator for determining the quality of an online service provided by a commodity object providing terminal is whether it can enable a user that purchases a commodity object to receive the purchased commodity object quickly.

At present, to resolve the foregoing problem, warehouse resource providing terminals and distribution resource providing terminals have emerged in the market. A commodity object providing terminal may acquire warehouse resources from a warehouse resource providing terminal to use the warehouse resources to store a commodity object, and may further acquire distribution resources from a distribution resource providing terminal to use the distribution resources to distribute a commodity object. However, most warehouse resources and distribution resources are scheduled by different providing terminals. As a result, the period from acquisition of a commodity object from a warehouse resource to distribution of the commodity object by using a distribution resource is relatively long. A user that purchases a commodity object cannot receive a purchased commodity object rapidly. Accordingly, the utilization of logistic resources (including warehouse resources and distribution resources) is relatively low.

In conclusion, a method for scheduling logistic resources is urgently needed to resolve the problem of relatively low utilization of logistic resources in existing technologies.

### SUMMARY

Embodiments of the present application provide a method, an apparatus, and a system for scheduling logistic resources, so as to resolve the problem of relatively low utilization of logistic resources in existing technologies.

A method for scheduling logistic resources may comprise:

determining a warehouse resource from a warehouse resource providing terminal and a distribution resource from a distribution resource providing terminal;

integrating the warehouse resource and the distribution resource according to a preset resource integration rule to obtain a logistic resource that satisfies a preset condition; and

releasing the logistic resource, to enable a commodity object providing terminal requesting to use the logistic resource to schedule the logistic resource.

In some embodiments, the warehouse resource comprises a warehouse capacity and an inventory turnover period. The determining of a warehouse resource from a warehouse resource providing terminal may comprise determining an inventory turnover period of a warehouse unit provided by the warehouse resource providing terminal according to a historical sales quantity and a historical sales volume ratio of the warehouse unit within a preset time period; and using at least one obtained inventory turnover period of the warehouse unit as an inventory turnover period of the warehouse resource providing terminal.

In some embodiments, the distribution resource may comprise a distribution attribute. The determining of a distribution resource from a distribution resource providing terminal may comprise receiving a distribution type, distribution routes, and a distribution capacity of each distribution route released by the distribution resource providing terminal; and determining the distribution attribute of the distribution resource providing terminal according to the distribution type, the distribution routes, and the distribution capacity of each distribution route.

In some embodiments, the integrating of the warehouse resource and the distribution resource according to a preset resource integration rule to obtain a logistic resource that satisfies a preset condition may comprise performing integration based on the preset resource integration rule, the warehouse capacity and the inventory turnover period of the warehouse resource, and the distribution attribute of the distribution resource, to obtain the logistic resource that satisfies the preset condition, wherein the preset condition is used to adjust the utilization of an integrated logistic resource.

In some embodiments, after the releasing of the logistic resource, the method may further comprise: receiving logistic resource order information sent by the commodity object providing terminal, wherein the logistic resource order information comprises a logistic resource selected by the commodity object providing terminal and commodity-object identifier information; and establishing a mapping relationship between the commodity-object identifier information and the selected logistic resource.

In some embodiments, after the releasing of the logistic resource, the method may further comprise: receiving order information sent by the commodity object providing terminal, wherein the order information comprises the commodity-object identifier information and identifier information of the commodity object providing terminal, wherein the order information further comprises distribution address information; determining the warehouse resource for the commodity object providing terminal according to the identifier information of the commodity object providing terminal; determining, according to the warehouse resource, warehouse units in which the commodity object corresponding to the commodity-object identifier information is located; according to the distribution address information, selecting, from the determined warehouse units, a warehouse unit whose distance from the distribution address information is less than a preset threshold; and sending the order information to the warehouse unit, and instructing the warehouse unit to perform dispatch and distribution according to the order information.

In some embodiments, the determining, according to the warehouse resource, of the warehouse units in which the commodity object corresponding to the commodity-object identifier information is located may comprise: if a quantity of pieces of commodity-object identifier information included in the order information is greater than one, respectively determining, according to the warehouse resource, a warehouse unit in which a commodity object corresponding to each piece of commodity-object identifier information is located; and the method may further comprise: if commodity objects corresponding to the commodity-object identifier information included in the order information are located in different warehouse units, dividing the order information into a plurality of pieces of sub-order information according to the warehouse units in which the commodity objects are located, wherein each piece of sub-order information comprises identifier information of the commodity objects that are located in the same warehouse unit and the distribution address information.

In some embodiments, the method may further comprise: monitoring an inventory quantity of the warehouse resource included in the logistic resource selected by the commodity object providing terminal; generating a branch-warehouse replenishment/allocation strategy according to the inventory quantity and a sales volume prediction value, wherein the sales volume prediction value is determined according to a sales volume prediction algorithm and historical sales volume data of warehouse units, and wherein the branch-warehouse replenishment/allocation strategy is configured to adjust inventory quantities of commodity objects in the warehouse units; and sending the branch-warehouse replenishment/allocation strategy to the commodity object providing terminal.

In some embodiments, during releasing of the logistic resource, the method may further comprise: determining cost information of different logistic resources, and displaying the cost information.

An apparatus for scheduling logistic resources may comprise a processor; and a memory storing instructions, wherein the instructions, when executed by the processor, perform the following operations:

determining a warehouse resource from a warehouse resource providing terminal and a distribution resource from a distribution resource providing terminal;

integrating the warehouse resource and the distribution resource according to a preset resource integration rule to obtain a logistic resource that satisfies a preset condition; and

releasing the logistic resource to allow a commodity object providing terminal requesting to use the logistic resource to schedule the logistic resource.

A system for scheduling logistic resources may comprise a front-end commodity-object presentation platform to be implemented by a computing device and a back-end logistics service platform to be implemented by the same or different computing device, where:

the front-end commodity-object presentation platform may be configured to release commodity object information provided by a commodity object providing terminal; and

the back-end logistics service platform may be configured to: determine a warehouse resource from a warehouse resource providing terminal and a distribution resource from a distribution resource providing terminal; integrate the warehouse resource and the distribution resource according to a preset resource integration rule to obtain a logistic resource that satisfies a preset condition; and release the logistic resource to allow a commodity object providing terminal requesting to use the logistic resource to schedule the logistic resource.

The beneficial effects of the present application are as follows:

In the embodiments of the present application, a warehouse resource from a warehouse resource providing terminal and a distribution resource from a distribution resource providing terminal are determined; the warehouse resource and the distribution resource are integrated according to a preset resource integration rule to obtain a logistic resource that satisfies a preset condition; and the logistic resource is released, enabling a commodity object providing terminal requesting to use the logistic resource to schedule the logistic resource. Based on a logistics service platform provided in the embodiments of the present application, a warehouse resource from a warehouse resource providing terminal and a distribution resource from a distribution resource providing terminal can be acquired, and the acquired warehouse resource and distribution resource are integrated or categorized, to obtain a logistic resource that satisfies a preset condition and release the logistic resource to a commodity object providing terminal, so that the commodity object providing terminal can schedule the logistic resource. Not only relatively scattered warehouse resources and distribution resources can be integrated into relatively unified logistic resources, but also utilization of these logistic resources can be improved, thereby effectively improving the efficiency of distributing a commodity object, shortening a time period between acquisition of a commodity object from a warehouse resource to distribution of the commodity object by using a distribution resource, and improving user experience of a user on an electronic commerce platform.

### BRIEF DESCRIPTION OF THE DRAWINGS

To describe the technical solutions of the embodiments of the present application more clearly, the following briefly introduces the accompanying drawings required for describing the embodiments. Apparently, the accompanying drawings in the following description show only some embodiments of the present application, and a person of ordinary skill in the art may still derive other drawings from these accompanying drawings without creative efforts.

FIG. 1 is a schematic flowchart of a method for scheduling logistic resources according to an embodiment of the present application;

FIG. 2 is a schematic diagram of a branch-warehouse replenishment/allocation strategy according to an embodiment of the present application;

FIG. 3 is a schematic structural diagram of an apparatus for scheduling logistic resources according to an embodiment of the present application; and

FIG. 4 is a schematic structural diagram of a system for scheduling logistic resources according to an embodiment of the present application.

### DETAILED DESCRIPTION OF THE INVENTION

To achieve the objective of the present application, the embodiments of the present application provide a method, an apparatus, and a system for scheduling logistic resources. Warehouse resources from different warehouse resource providing terminals and distribution resources from different distribution resource providing terminals are determined; the warehouse resources and the distribution resources are integrated according to a preset resource integration rule to obtain a logistic resource that satisfies a preset condition; and the logistic resource is released, enabling a commodity object providing terminal requesting to use the logistic resource to schedule the logistic resource.

Based on a logistics service platform provided in the embodiments of the present application, warehouse resources from different warehouse resource providing terminals and distribution resources from different distribution resource providing terminals can be acquired, and the acquired warehouse resources and distribution resources are integrated or categorized, to obtain a logistic resource that satisfies a preset condition and release the logistic resource to a commodity object providing terminal, enabling the commodity object providing terminal to schedule the logistic resource. Not only relatively scattered warehouse resources and distribution resources can be integrated into relatively unified logistic resources, but also utilization of these logistic resources can be improved, thereby effectively improving the efficiency of distributing a commodity object, shortening a time period between acquisition of a commodity object from a warehouse resource to distribution of the commodity object by using a distribution resource, and improving user experience of a user on an electronic commerce platform.

Embodiments of the present application may be applied to a logistics service platform system. The logistics service platform has a capability of integrating warehouse resources and distribution resources, and integrates relatively scattered warehouse resources and distribution resources to obtain unified logistic resources. When providing these logistic resources to a commodity object providing terminal, the logistics service platform can provide the commodity object providing terminal with characteristics such as warehouse management, order routing, automatic dispatch, and rapid distribution, thereby reducing the inventory cost and logistics cost for the commodity object providing terminal. Therefore, both a commodity object providing terminal and a commodity object demander enjoy a rapid and convenient logistics service.

The following describes the embodiments of the present application in further detail with reference to the accompanying drawings. Apparently, the described embodiments may be only part of the embodiments of the present application rather than all of the embodiments. All other embodiments obtained by a person of ordinary skill in the art based on the embodiments of the present application without creative efforts shall fall within the protection scope of the present application.

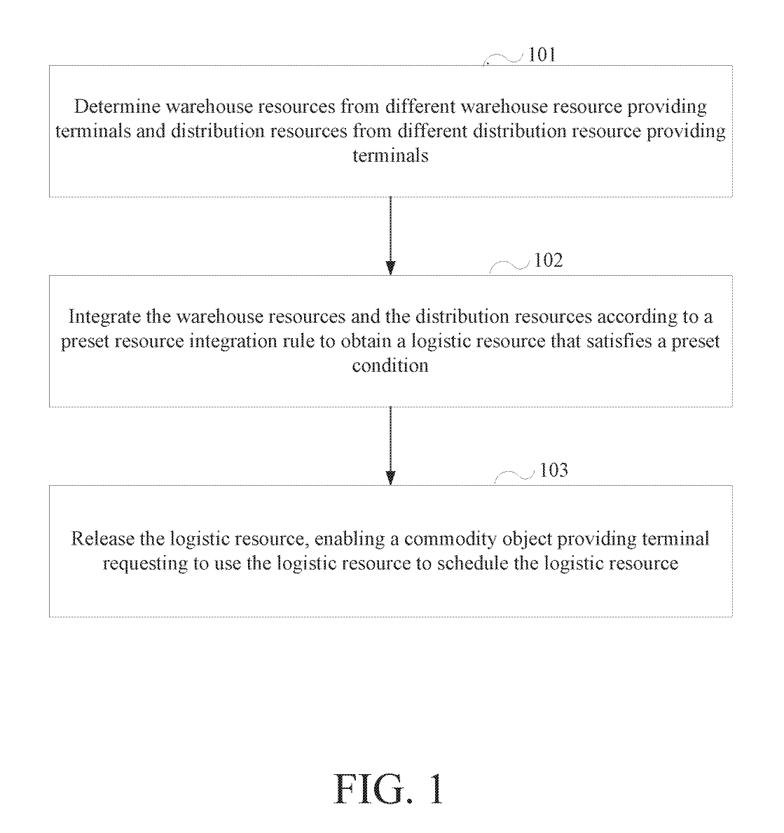

FIG. 1 is a schematic flowchart of a method for scheduling logistic resources according to an embodiment of the present application. The method may be shown as follows.

At step 101: a warehouse resource from a warehouse resource providing terminal and a distribution resource from a distribution resource providing terminal may be determined.

The warehouse resource includes a warehouse capacity and an inventory turnover period, and the distribution resource includes a distribution attribute.

In some embodiments, at step 101, a logistics service platform may provide a plurality of interfaces. Different warehouse resource providing terminals send warehouse resources to the logistics service platform through these interfaces, and different distribution resource providing terminals send distribution resources to the logistics service platform through these interfaces. In this way, the logistics service platform may determine multiple warehouse resources from the different warehouse resource providing terminals and multiple distribution resources from the different distribution resource providing terminals in real time.

An example in which a warehouse resource includes an inventory turnover period is used below to describe how to determine a warehouse resource from a warehouse resource providing terminal.

In some embodiments, an inventory turnover period of a warehouse unit is determined according to a historical sales quantity and a historical sales volume ratio within a preset time period of the warehouse unit provided by the warehouse resource providing terminal; and at least one obtained inventory turnover period of the warehouse unit is used as an inventory turnover period of the warehouse resource providing terminal.

The inventory turnover period herein may refer to the time period between a commodity's entering the warehouse and out of the warehouse.

For example, a warehouse unit's historical sales quantity and historical sales volume ratio within a preset time period may be collected from the warehouse resource providing terminal. A sales volume prediction algorithm may be used to predict a sales volume within a future time period. The inventory turnover period of the warehouse unit may be determined according to the predicted sales volume. For example, if the sales volume has a larger value, the inventory turnover period is shorter. In contrast, if the sales volume has a smaller value, the inventory turnover period is longer.

A replenishment plan of a commodity object providing terminal using the warehouse unit may be predicted or a circulation time of the warehouse unit may be determined according to the determined inventory turnover period.

In some embodiments, a level of the warehouse unit may be used to determine the inventory turnover period. Alternatively, a location of the warehouse unit may be used to determine the inventory turnover period.

In addition, the warehouse resource may further include a warehouse capacity, a warehouse level (e.g., when a coverage area of a warehouse unit is larger, a warehouse level is higher), a location of a warehouse unit, a warehouse type, and charging information of different warehouse units, and the like.

An example in which a distribution resource includes a distribution attribute is used below to describe how to determine a distribution resource from a distribution resource providing terminal.

In some embodiments, a distribution type, distribution routes, and a distribution capacity of each distribution route that are released by a distribution resource providing terminal are received; and a distribution attribute of the distribution resource providing terminal is determined according to the distribution type, the distribution routes, and the distribution capacity of each distribution route.

The distribution attribute herein may refer to a type and a distribution time limit of a distributed commodity object.

A distribution attribute mainly depends on two aspects of factors: one aspect is a distance between a ship-from address of a commodity object and a ship-to address of a user. The other aspect is a transportation tool used for distribution and a route used for distribution (also referred to as a distribution route). In some embodiments, relationships between a distribution attribute and a distribution type, distribution routes, and a distribution capacity of each distribution route may be determined according to distribution data provided by the distribution resource providing terminal.

Optionally, before step 101 is performed, the method further includes the followings.

Identity of the warehouse resource providing terminal may be verified through an external interface. Identity of the distribution resource providing terminal may also be verified. In this way, security of a commodity object of the commodity object providing terminal may be guaranteed.

At step 102, the warehouse resource and the distribution resource may be integrated according to a preset resource integration rule to obtain a logistic resource that satisfies a preset condition.

In some embodiments, at step 102, integration is performed based on the preset resource integration rule, the warehouse capacity and the inventory turnover period included in the warehouse resource, and the distribution attribute included in the distribution resource, to obtain the logistic resource that satisfies the preset condition, where the preset condition is used to adjust the utilization of the integrated logistic resource.

For example, the warehouse resource is categorized according to the warehouse capacity and/or the inventory turnover period to obtain a first category. The distribution resource is categorized according to the distribution attribute to obtain a second category. The first category and the second category are integrated to obtain a type of logistic resource that satisfies a preset condition.

In another example, the determined warehouse resources include a warehouse resource 1, a warehouse resource 2, and a warehouse resource 3. A warehouse capacity of the warehouse resource 1 is X, and an inventory turnover period of the warehouse resource 1 is 10 days. A warehouse capacity of the warehouse resource 2 is Y, and an inventory turnover period of the warehouse resource 2 is 20 days. A warehouse capacity of the warehouse resource 3 is Z, and an inventory turnover period of the warehouse resource 3 is 5 days. X is greater than Z, Z is less than Y, and Y is greater than X. The determined distribution resources include a distribution resource 1, a distribution resource 2, and a distribution resource 3. A distribution attribute of the distribution resource 1 is to support distribution of large home appliances, and a distribution time limit of the distribution resource 1 is 3 days. A distribution attribute of the distribution resource 2 is to support distribution of commodity objects having a high timeliness requirement (for example, vegetables), and a distribution time limit of the distribution resource 2 is 1 day. A distribution attribute of the distribution resource 3 is to support distribution of common commodity objects, and a distribution time limit of the distribution resource 3 is 1 day to 3 days. Based on the information, the warehouse resources and the distribution resources may be integrated as follows according to a preset resource integration rule.

The warehouse resource 2 and the distribution resource 3 are integrated into a logistic resource, and the integrated logistic resource is applicable to common commodity objects. The warehouse resource 1 and the distribution resource 2 are integrated into a logistic resource, and the logistic resource is applicable to large home appliances. The warehouse resource 3 and the distribution resource 1 are integrated into a logistic resource, and the logistic resource is applicable to commodity objects that have a relatively high timeliness requirement (for example, vegetables).

In another example, the determined warehouse resources include a warehouse resource 1, a warehouse resource 2, and a warehouse resource 3, and the determined distribution resources include a distribution resource 1, a distribution resource 2, and a distribution resource 3. The warehouse resources and the distribution resources may be combined according to a preset condition different from that of the previous example, to obtain combined logistic resources.

The resource integration rule may be a rule for combining different resources. For example, the geographical locations of the warehouse resource and the distribution resource to be combined may be within the same area. That is, the warehouse resource and the distribution resource belonging to the same geographical area may be combined into a logistic resource.

The resource integration rule recorded herein may be determined by using a resource integration algorithm, or may be obtained by analyzing historical data, or may be manually preset. How to obtain a resource integration rule is not specifically limited herein.

At step 103: the logistic resource may be released to allow a commodity object providing terminal requesting to use the logistic resource to schedule the logistic resource.

In some embodiments, at step 103, the logistic resources determined in step 102 are released, so that a commodity object providing terminal can freely select a needed logistic resource.

In some embodiments, after the releasing of the logistic resource, the method further includes:

receiving logistic resource order information sent by the commodity object providing terminal, where the logistic resource order information includes a logistic resource selected by the commodity object providing terminal and the logistic resource order information also includes commodity-object identifier information; and

establishing a mapping relationship between the commodity-object identifier information and the selected logistic resource.

When the logistics service platform releases logistic resources, the commodity object providing terminal may acquire these logistic resources through the logistics service platform, and according to an attribute of the commodity object to be provided to a user, select a logistic resource matching the attribute of the commodity object.

For example, a commodity object provided by a commodity object providing terminal is a large home appliance. Accordingly, the logistic resource including the warehouse resource 1 and the distribution resource 2 at step 102 may be selected.

When selecting the logistic resource that matches the attribute of the commodity object, the commodity object providing terminal sends logistic resource order information to the logistics service platform. The logistic resource order information may include the commodity-object identifier information, or identifier information of the commodity object providing terminal. If the logistic resource order information includes the commodity-object identifier information, it is regarded that the logistic resource is used for the commodity object.

In some embodiments, the logistics service platform may establish a mapping relationship between the commodity-object identifier information and the selected logistic resource, or may establish a mapping relationship between the identifier information of the commodity object providing terminal and the selected logistic resource. In this way, it becomes convenient to rapidly determine a logistic resource when order information is received subsequently.

In some embodiments, after the releasing of the logistic resource, the method further includes:

receiving order information sent by the commodity object providing terminal, where the order information includes the commodity-object identifier information and the identifier information of the commodity object providing terminal, where the order information further includes distribution address information;

determining the warehouse resource for the commodity object providing terminal according to the identifier information of the commodity object providing terminal;

determining, according to the warehouse resource, warehouse units in which the commodity object corresponding to the commodity-object identifier information is located;

according to the distribution address information, selecting, from the determined warehouse units, a warehouse unit whose distance from the address indicated in the distribution address information is less than a preset threshold; and

sending the order information to the selected warehouse unit, and instructing the selected warehouse unit to perform dispatch and distribution according to the order information.

After the logistic resource is released, when receiving order information submitted by a user on a front-end commodity-object presentation platform, the commodity object providing terminal may route the order information to the logistics service platform. For example, the order information includes commodity-object identifier information, identifier information of the commodity object providing terminal, and distribution address information.

In some embodiments, the logistics service platform determines, according to the identifier information of the commodity object providing terminal included in the order information, a warehouse resource selected by the commodity object providing terminal, and further determines, according to the warehouse resource, the warehouse units in which the commodity object corresponding to the commodity-object identifier information is located.

In some embodiments, the commodity object providing terminal selects more than one warehouse resource, and multiple warehouse units in which the commodity object corresponding to the commodity-object identifier information is located may be determined according to the more than one warehouse resource. Therefore, to rapidly deliver the commodity object to the user, a warehouse unit that is relatively closer to a distribution address of the user may be selected. The order information is sent to the selected warehouse unit, and the warehouse unit is instructed to perform dispatch and distribution according to the order information.

In addition, the order information submitted by the user may include multiple pieces of commodity-object identifier information. A warehouse unit in which a commodity object corresponding to each piece of commodity-object identifier information is located is determined according to the warehouse resource. However, if commodity objects corresponding to these pieces of commodity-object identifier information are distributed in different warehouse units, the order information is divided into pieces of sub-order information according to the warehouse units in which the commodity objects are located. Each piece of sub-order information includes identifier information of the commodity objects that are located in the same warehouse unit and the distribution address information.

When the division of one piece of order information is initiated, the division may further be performed according to label information included in the order information, or may be performed according to location information of a warehouse unit, or may further be performed in another manner. How division is performed is not specifically limited herein, provided that the user can receive a commodity object as soon as possible.

In some embodiments, after the releasing of the logistic resource, the method further includes:

monitoring an inventory quantity of the warehouse resource included in the logistic resource selected by the commodity object providing terminal;

generating a branch-warehouse replenishment/allocation strategy according to the inventory quantity and a sales volume prediction value, where the sales volume prediction value is determined according to a sales volume prediction algorithm and historical sales volume data of the warehouse units, and the branch-warehouse replenishment/allocation strategy is used to adjust inventory quantities of commodity objects in different warehouse units; and

sending the branch-warehouse replenishment/allocation strategy to the commodity object providing terminal.

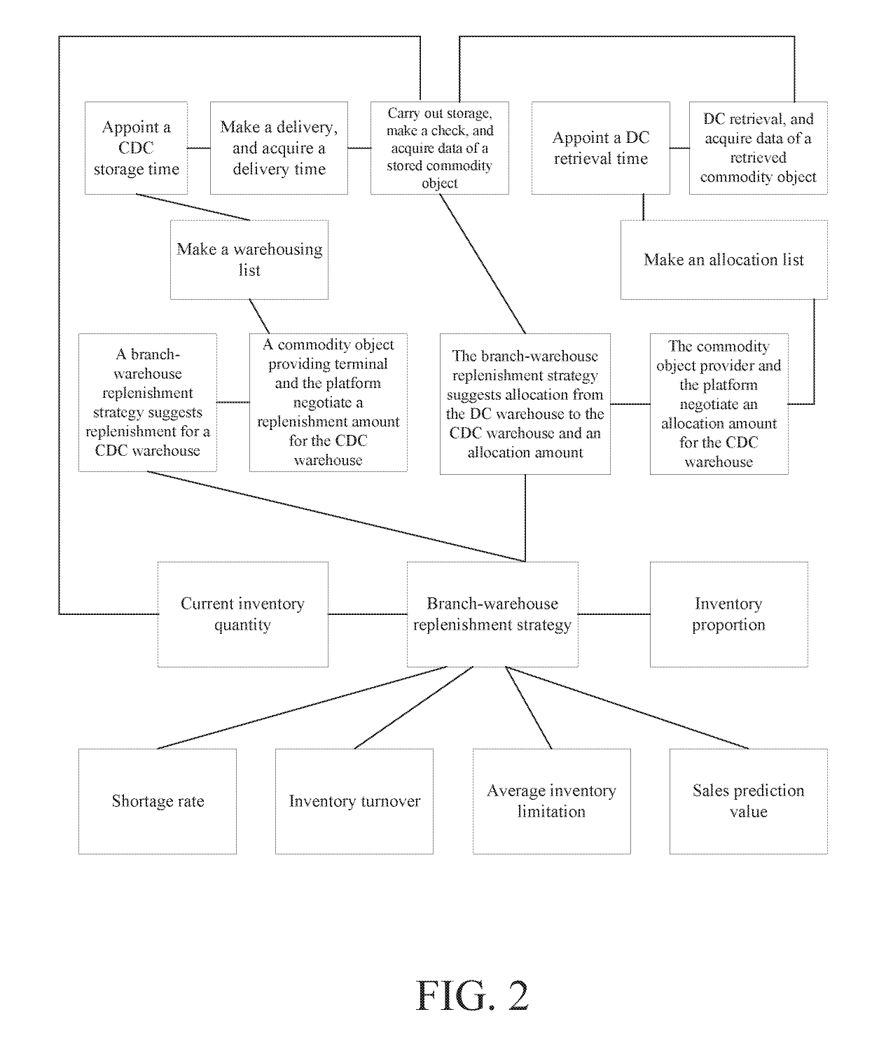

FIG. 2 is a schematic diagram of a branch-warehouse replenishment/allocation strategy according to an embodiment of the present application.

As shown in FIG. 2, a logistics service system monitors information such as an inventory quantity of the warehouse resource included in the logistic resource, and an inventory proportion, a sales prediction value, a shortage rate, an average inventory limitation, and an inventory turnover of each warehouse unit, to generate a branch-warehouse replenishment/allocation strategy. The branch-warehouse replenishment/allocation strategy is sent to a corresponding warehouse unit (e.g., a CDC warehouse or a DC warehouse) and commodity object providing terminal. A CDC warehouse shown in FIG. 2 refers to one warehouse unit, and a DC warehouse refers to another warehouse unit.

When the commodity object providing terminal confirms the branch-warehouse replenishment/allocation strategy, a branch-warehouse replenishment/allocation procedure is initiated. As shown in FIG. 2, the branch-warehouse replenishment strategy may suggest replenishment for a CDC warehouse. A commodity object providing terminal and the platform (e.g., the logistics service platform) may negotiate a replenishment amount for the CDC warehouse, make a warehousing list, appoint a CDC storage time, make a delivery and acquire a delivery time. The commodity object providing terminal and the platform may carry out storage, make a check, and acquire data of a stored commodity object.

Also as shown in FIG. 2, in some embodiments, the branch-warehouse replenishment strategy may suggest allocation from the DC warehouse to the CDC warehouse and also suggest an allocation amount. The commodity object providing terminal and the platform (e.g., the logistics service platform) may negotiate an allocation amount for the CDC warehouse, make an allocation list, appoint a DC retrieval time, perform DC retrieval and acquire data of a retrieved commodity object. The commodity object providing terminal and the platform may also carry out storage, make a check, and acquire data of a stored commodity object.

In some embodiments, the branch-warehouse replenishment strategy may be to acquire a commodity object from a commodity object providing terminal and store the acquired commodity object to a warehouse unit, or may be to allocate a commodity object from one warehouse unit to another warehouse unit.

The branch-warehouse replenishment/allocation strategy may be a branch-warehouse replenishment strategy, or may be a branch-warehouse allocation strategy, or may be a combination of the branch-warehouse replenishment strategy and the branch-warehouse allocation strategy.

In some embodiments, during the releasing of the logistic resource, the method further includes:

determining cost information of different logistic resources, and displaying the cost information.

In some embodiments, a logistics service platform may acquire, warehouse resources from different warehouse resource providing terminals and distribution resources from different distribution resource providing terminals, integrate or categorize the acquired warehouse resources and distribution resources to obtain a logistic resource that satisfies a preset condition, and release the logistic resource to a commodity object providing terminal to allow the commodity object providing terminal to schedule the logistic resource. Not only relatively scattered warehouse resources and distribution resources can be integrated into relatively unified logistic resources, but also utilization of these logistic resources can be improved, thereby effectively improving the efficiency of distributing a commodity object, shortening a time period between acquisition of a commodity object from a warehouse resource to distribution of the commodity object by using a distribution resource, and improving user experience of a user on an electronic commerce platform.

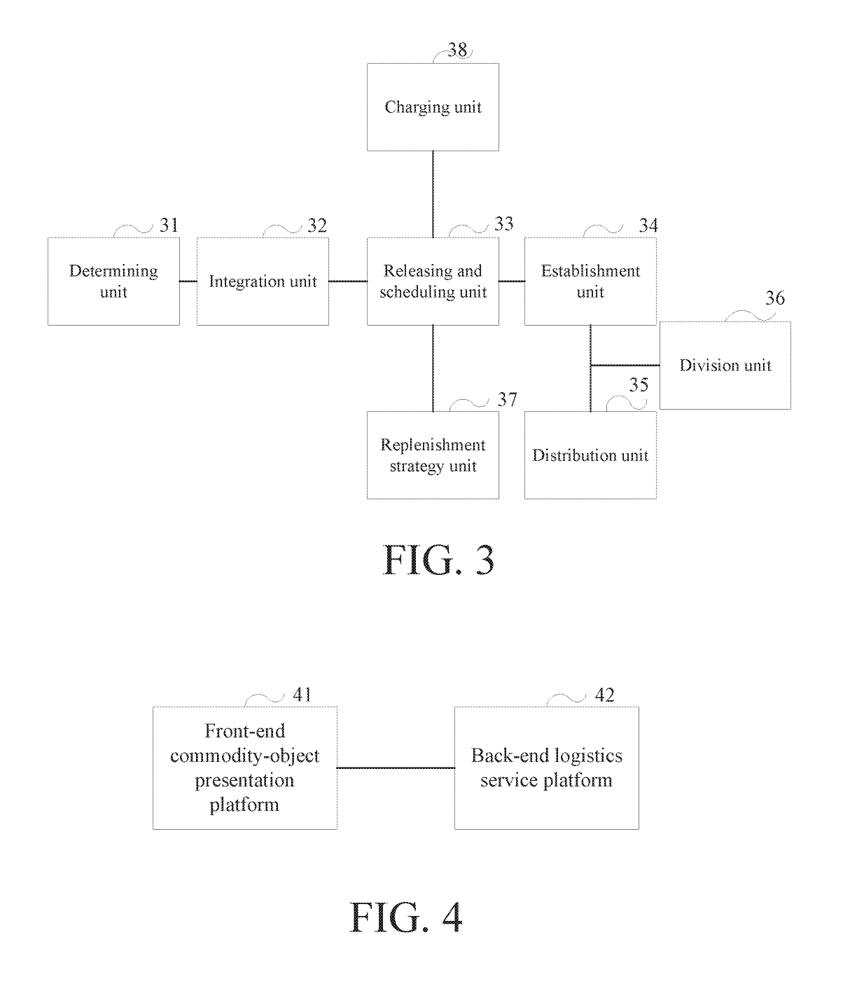

FIG. 3 is a schematic structural diagram of an apparatus for scheduling logistic resources according to an embodiment of the present application. The scheduling apparatus includes a determining unit 31, an integration unit 32, and a releasing and scheduling unit 33.

The determining unit 31 is configured to determine warehouse resources from different warehouse resource providing terminals and distribution resources from different distribution resource providing terminals.

The integration unit 32 is configured to integrate the warehouse resources and the distribution resources according to a preset resource integration rule to obtain a logistic resource that satisfies a preset condition.

The releasing and scheduling unit 33 is configured to release the logistic resource to allow a commodity object providing terminal requesting to use the logistic resource to schedule the logistic resource.

In another embodiment of the present application, if the warehouse resource includes a warehouse capacity and an inventory turnover period, the determining, by the determining unit 31, of a warehouse resource from a warehouse resource providing terminal includes:

determining an inventory turnover period of a warehouse unit provided by the warehouse resource providing terminal according to a historical sales quantity and a historical sales volume ratio of the warehouse unit within a preset time period; and

using at least one obtained inventory turnover period of the warehouse unit as an inventory turnover period of the warehouse resource providing terminal.

In some embodiments, if the distribution resource includes a distribution attribute, the determining, by the determining unit 31, of a distribution resource from a distribution resource providing terminal includes:

receiving a distribution type, distribution routes, and a distribution capacity of each distribution route released by the distribution resource providing terminal; and

determining the distribution attribute of the distribution resource providing terminal according to the distribution type, the distribution routes, and the distribution capacity of each distribution route.

In some embodiments, the integrating, by the integration unit 32, of the warehouse resources and the distribution resources according to a preset resource integration rule to obtain a logistic resource that satisfies a preset condition includes:

performing integration based on the preset resource integration rule, the warehouse capacity and the inventory turnover period included in the warehouse resource, and the distribution attribute included in the distribution resource, to obtain the logistic resource that satisfies the preset condition, where the preset condition is used to adjust the utilization of an integrated logistic resource.

In some embodiments, the scheduling apparatus further includes an establishment unit 34.

The establishment unit 34 is configured to: after the logistic resource is released, receive logistic resource order information sent by the commodity object providing terminal, where the logistic resource order information includes a logistic resource selected by the commodity object providing terminal and commodity-object identifier information; and

establish a mapping relationship between the commodity-object identifier information and the selected logistic resource.

In some embodiments, the scheduling apparatus further includes a distribution unit 35.

The distribution unit 35 is configured to: after the logistic resource is released, receive order information sent by the commodity object providing terminal, wherein the order information includes the commodity-object identifier information and identifier information of the commodity object providing terminal, where the order information further includes distribution address information;

determine the warehouse resource for the commodity object providing terminal according to the identifier information of the commodity object providing terminal;

determine, according to the warehouse resource, the warehouse units in which the commodity object corresponding to the commodity-object identifier information is located;

according to the distribution address information, select, from the determined warehouse units, a warehouse unit whose distance from the address indicated in the distribution address information is less than a preset threshold; and

send the order information to the selected warehouse unit, and instruct the selected warehouse unit to perform dispatch and distribution according to the order information.

In some embodiments, the determining, by the distribution unit 35 according to the warehouse resource, of the warehouse units in which the commodity object corresponding to the commodity-object identifier information is located includes:

if a quantity of pieces of commodity-object identifier information included in the order information is greater than one, determining, according to the warehouse resource, a warehouse unit in which a commodity object corresponding to each piece of commodity-object identifier information is located.

In some embodiments, the scheduling apparatus further includes a division unit 36.

The division unit is configured to: if commodity objects corresponding to the commodity-object identifier information included in the order information are located in different warehouse units, divide the order information into multiple pieces of sub-order information according to the warehouse units in which the commodity objects are located, where each piece of sub-order information includes identifier information of the commodity objects that are located in the same warehouse unit, where the each piece of sub-order information may also include the distribution address information.

In some embodiments, the scheduling apparatus further includes a replenishment strategy unit 37.

The replenishment strategy unit 37 is configured to: monitor an inventory quantity of the warehouse resource included in the logistic resource selected by the commodity object providing terminal;

generate a branch-warehouse replenishment/allocation strategy according to the inventory quantity and a sales volume prediction value, where the sales volume prediction value is determined according to a sales volume prediction algorithm and historical sales volume data of warehouse units, and the branch-warehouse replenishment/allocation strategy is configured to adjust inventory quantities of commodity objects in the warehouse units; and

send the branch-warehouse replenishment/allocation strategy to the commodity object providing terminal.

In some embodiments, the scheduling apparatus further includes a charging unit 38.

The charging unit 38 is configured to: when the logistic resource is being released, determine cost information of different logistic resources, and display the cost information.

The scheduling apparatus recorded in this embodiment of the present application may be implemented by hardware or may be implemented by software. This is not specifically limited herein. A scheduling apparatus can acquire warehouse resources from different warehouse resource providing terminals and distribution resources from different distribution resource providing terminals, and integrate or categorize the acquired warehouse resources and distribution resources, to obtain a logistic resource that satisfies a preset condition and release the logistic resource to a commodity object providing terminal to allow the commodity object providing terminal to schedule the logistic resource. Not only relatively scattered warehouse resources and distribution resources can be integrated into relatively unified logistic resources, but also utilization of these logistic resources can be improved, thereby effectively improving the efficiency of distributing a commodity object, shortening a time period between acquisition of a commodity object from a warehouse resource to distribution of the commodity object by using a distribution resource, and improving user experience of a user on an electronic commerce platform.

FIG. 4 is a schematic structural diagram of a system for scheduling logistic resources according to an embodiment of the present application. The system includes a front-end commodity-object presentation platform 41 and a back-end logistics service platform 42.

The front-end commodity-object presentation platform 41 is configured to release commodity object information provided by a commodity object providing terminal.

The back-end logistics service platform 42 is configured to: determine warehouse resources from different warehouse resource providing terminals and distribution resources from a different distribution resource providing terminals, where the warehouse resources include a warehouse capacity and an inventory turnover period, and the distribution resources include a distribution attribute; integrate the warehouse resources and the distribution resources according to a preset resource integration rule to obtain a logistic resource that satisfies a preset condition; and release the logistic resource to allow a commodity object providing terminal requesting to use the logistic resource to schedule the logistic resource.

In this embodiment of the present application, the back-end logistics service platform 42 includes a warehouse resource platform and a distribution resource platform and has the same or similar functions recorded in the foregoing embodiments. Details are not repeated herein.

A person skilled in the art should understand that the embodiments of the present application may be provided as a method, an apparatus (device), or a computer program product. Therefore, the present application may use a form of a hardware embodiment, a software embodiment, or an embodiment combining software and hardware. In addition, the present application may use a form of a computer program product implemented on one or more computer readable storage media (including but not limited to a disk memory, a CD-ROM, and an optical memory) including computer readable program code.

The present application is described with reference to flowcharts and/or block diagrams of the method, the apparatus (device), and the computer program product in the embodiments of the present application. It should be understood that computer program instructions can implement each process and/or block in the flowcharts and/or block diagrams and a combination of processes and/or blocks in the flowcharts and/or block diagrams. These computer program instructions may be provided to a general-purpose computer, an application-specific computer, an embedded processor, or a processor of another programmable data processing apparatus to generate a machine, so that an apparatus configured to implement functions specified in one or more processes in the flowcharts and/or one or more blocks in the block diagrams is generated by using instructions executed by the computer or the processor of another programmable data processing apparatus.

These computer program instructions may also be stored in a computer readable memory that can guide a computer or another programmable data processing apparatus to work in a specific manner. These computer program instructions may also be loaded into a computer or another programmable data processing apparatus, so that a series of operation steps are performed on the computer or another programmable apparatus to generate processing implemented by a computer, and instructions executed on the computer or another programmable apparatus provide steps for implementing functions specified in one or more processes in the flowcharts and/or one or more blocks in the block diagrams.

Although preferred embodiments of the present application are described, once acquiring basic innovative concepts, a person skilled in the art may make other changes and modifications to these embodiments. Therefore, the appended claims intend to be explained to include preferred embodiments and all changes and modifications that fall within scope of the present application.

A person skilled in the art may make various modifications and variations to the present application without departing from the spirit and scope of the present application. In this way, if these modifications and variations to the present application fall within the scope of claims of the present application and equivalent technologies thereof, the present application also intends to cover these modifications and variations.

What is claimed is:

1. A method to be implemented by a computing device for scheduling logistic resources, comprising:
determining a warehouse resource from a warehouse resource providing terminal and a distribution resource from a distribution resource providing terminal;
integrating the warehouse resource and the distribution resource according to a resource integration rule to obtain a logistic resource that satisfies a condition; and
releasing the logistic resource, to enable a commodity object providing terminal requesting to use the logistic resource to schedule the logistic resource.

2. The scheduling method according to claim 1, wherein the warehouse resource comprises a warehouse capacity and an inventory turnover period; and
wherein the determining of a warehouse resource from a warehouse resource providing terminal comprises:
determining an inventory turnover period of a warehouse unit provided by the warehouse resource providing terminal according to a historical sales quantity and a historical sales volume ratio of the warehouse unit within a time period; and
using at least one obtained inventory turnover period of the warehouse unit as an inventory turnover period of the warehouse resource providing terminal.

3. The scheduling method according to claim 1, wherein the distribution resource comprises a distribution attribute; and
wherein the determining of a distribution resource from a distribution resource providing terminal comprises:
receiving a distribution type, distribution routes, and a distribution capacity of each distribution route released by the distribution resource providing terminal; and
determining the distribution attribute of the distribution resource providing terminal according to the distribution type, the distribution routes, and the distribution capacity of each distribution route.

4. The scheduling method according to claim 1, wherein the integrating of the warehouse resource and the distribution resource according to a resource integration rule to obtain a logistic resource that satisfies a condition comprises:
performing integration based on the resource integration rule, the warehouse capacity and the inventory turnover period of the warehouse resource, and the distribution attribute of the distribution resource, to obtain the logistic resource that satisfies the condition, wherein the condition is used to adjust the utilization of an integrated logistic resource.

5. The scheduling method according to claim 1, wherein after the releasing of the logistic resource, the method further comprises:
receiving logistic resource order information sent by the commodity object providing terminal, wherein the logistic resource order information comprises a logistic resource selected by the commodity object providing terminal and commodity-object identifier information; and
establishing a mapping relationship between the commodity-object identifier information and the selected logistic resource.

6. The scheduling method according to claim 1, wherein after the releasing of the logistic resource, the method further comprises:
receiving order information sent by the commodity object providing terminal, wherein the order information comprises the commodity-object identifier information and identifier information of the commodity object providing terminal, wherein the order information further comprises distribution address information;
determining the warehouse resource for the commodity object providing terminal according to the identifier information of the commodity object providing terminal;
determining, according to the warehouse resource, warehouse units in which the commodity object corresponding to the commodity-object identifier information is located;
according to the distribution address information, selecting, from the determined warehouse units, a warehouse unit whose distance from the distribution address information is less than a threshold; and
sending the order information to the warehouse unit, and instructing the warehouse unit to perform dispatch and distribution according to the order information.

7. The scheduling method according to claim 6, wherein the determining, according to the warehouse resource, of the warehouse units in which the commodity object corresponding to the commodity-object identifier information is located comprises:
if a quantity of pieces of commodity-object identifier information included in the order information is greater than one, respectively determining, according to the warehouse resource, a warehouse unit in which a commodity object corresponding to each piece of commodity-object identifier information is located; and
wherein the method further comprises:
if commodity objects corresponding to the commodity-object identifier information included in the order information are located in different warehouse units, dividing the order information into a plurality of pieces of sub-order information according to the warehouse units in which the commodity objects are located, wherein each piece of sub-order information comprises identifier information of the commodity objects that are located in the same warehouse unit and the distribution address information.

8. The scheduling method according to claim 1, wherein the method further comprises:
monitoring an inventory quantity of the warehouse resource included in the logistic resource selected by the commodity object providing terminal;
generating a branch-warehouse replenishment/allocation strategy according to the inventory quantity and a sales volume prediction value, wherein the sales volume prediction value is determined according to a sales volume prediction algorithm and historical sales volume data of warehouse units, and wherein the branch-warehouse replenishment/allocation strategy is configured to adjust inventory quantities of commodity objects in the warehouse units; and
sending the branch-warehouse replenishment/allocation strategy to the commodity object providing terminal.

9. The scheduling method according to claim 1, wherein during releasing of the logistic resource, the method further comprises:
determining cost information of different logistic resources, and displaying the cost information.

10. An apparatus for scheduling logistic resources, comprising:
a processor; and
a memory storing instructions, wherein the instructions, when executed by the processor, cause the apparatus to perform the following operations:
determining a warehouse resource from a warehouse resource providing terminal and a distribution resource from a distribution resource providing terminal;
integrating the warehouse resource and the distribution resource according to a resource integration rule to obtain a logistic resource that satisfies a condition; and
releasing the logistic resource to allow a commodity object providing terminal requesting to use the logistic resource to schedule the logistic resource.

11. The apparatus according to claim 10, wherein the warehouse resource comprises a warehouse capacity and an inventory turnover period; and
wherein the determining of a warehouse resource from a warehouse resource provider side comprises:
determining an inventory turnover period of a warehouse unit provided by the warehouse resource providing terminal according to a historical sales quantity and a historical sales volume ratio of the warehouse unit within a time period; and
using at least one obtained inventory turnover period of the warehouse unit as an inventory turnover period of the warehouse resource providing terminal.

12. The apparatus according to claim 10, wherein the distribution resource comprises a distribution attribute; and
wherein the determining of a distribution resource from a distribution resource providing terminal comprises:
receiving a distribution type, distribution routes, and a distribution capacity of each distribution route released by the distribution resource providing terminal; and
determining the distribution attribute of the distribution resource providing terminal according to the distribution type, the distribution routes, and the distribution capacity of each distribution route.

13. The apparatus according to claim 10, wherein the integrating of the warehouse resource and the distribution resource according to a resource integration rule to obtain a logistic resource that satisfies a condition comprises:
performing integration based on the resource integration rule, the warehouse capacity and the inventory turnover period of the warehouse resource, and the distribution attribute of the distribution resource, to obtain the logistic resource that satisfies the condition, wherein the condition is used to adjust the utilization of an integrated logistic resource.

14. The apparatus according to claim 10, wherein the instructions, when executed by the processor, further perform the following operations:
after the logistic resource is released, receiving logistic resource order information sent by the commodity object providing terminal, wherein the logistic resource order information comprises a logistic resource selected by the commodity object providing terminal and commodity-object identifier information; and
establishing a mapping relationship between the commodity-object identifier information and the selected logistic resource.

15. The apparatus according to claim 10, wherein the instructions, when executed by the processor, further perform the following operations:
after the logistic resource is released, receiving order information sent by the commodity object providing terminal, wherein the order information comprises the commodity-object identifier information and identifier information of the commodity object providing terminal, wherein the order information further comprises distribution address information;
determining the warehouse resource from the commodity object providing terminal according to the identifier information of the commodity object providing terminal;
determining, according to the warehouse resource, warehouse units in which the commodity object corresponding to the commodity-object identifier information is located;
according to the distribution address information, selecting, from the determined warehouse units, a warehouse unit whose distance from the distribution address information is less than a threshold; and
sending the order information to the warehouse unit, and instructing the warehouse unit to perform dispatch and distribution according to the order information.

16. The apparatus according to claim 15, wherein the determining according to the warehouse resource, of the warehouse units in which the commodity object corresponding to the commodity-object identifier information is located comprises:
if a quantity of pieces of commodity-object identifier information included in the order information is greater than one, respectively determining, according to the warehouse resource, a warehouse unit in which a commodity object corresponding to each piece of commodity-object identifier information is located; and
wherein the instructions, when executed by the processor, further perform the following operation:
if commodity objects corresponding to the commodity-object identifier information included in the order information are located in different warehouse units, dividing the order information into a plurality of pieces of sub-order information according to the warehouse units in which the commodity objects are located, wherein each piece of sub-order information comprises identifier information of the commodity objects that are located in the same warehouse unit and the distribution address information.

17. The apparatus according to claim 10, wherein the instructions, when executed by the processor, further perform the following operations:
monitoring an inventory quantity of the warehouse resource included in the logistic resource selected by the commodity object providing terminal;
generating a branch-warehouse replenishment/allocation strategy according to the inventory quantity and a sales volume prediction value, wherein the sales volume prediction value is determined according to a sales volume prediction algorithm and historical sales volume data of warehouse units, and the branch-warehouse replenishment/allocation strategy is used to adjust inventory quantities of commodity objects in the warehouse units; and
sending the branch-warehouse replenishment/allocation strategy to the commodity object providing terminal.

18. The apparatus according to claim 10, wherein the instructions, when executed by the processor, further perform the following operation:
when the logistic resource is being released, determining cost information of different logistic resources, and displaying the cost information.

19. A system for scheduling logistic resources, the system comprising a front-end commodity-object presentation platform to be implemented by a computing device and a back-end logistics service platform to be implemented by the same or different computing device, wherein:
the front-end commodity-object presentation platform is configured to release commodity object information provided by a commodity object provider side; and
the back-end logistics service platform is configured to: determine a warehouse resource from a warehouse resource providing terminal and a distribution resource from a distribution resource providing terminal; integrate the warehouse resource and the distribution resource according to a resource integration rule to obtain a logistic resource that satisfies a condition; and release the logistic resource to allow a commodity object provider side requesting to use the logistic resource to schedule the logistic resource.
